(19) United States
(12) Patent Application Publication
(10) Pub. No.: US 2026/0220875 A1
(43) Pub. Date: Jul. 30, 2026

(54) GAUSSIAN SPLATTING OPTIMIZATION WITH ENTROPY CONSTRAINTS

(71) Applicant: InterDigital VC Holdings, Inc., Wilmington, DE (US)

(72) Inventors: Jiahao Pang, Plainsboro, NJ (US); Yuning Huang, West Lafayette, IN (US); Dong Tian, Boxborough, MA (US)

(21) Appl. No.: 19/041,527

(22) Filed: Jan. 30, 2025

(51) Int. Cl. G06T 15/08; G06T 7/00; G06T 15/20; G06T 19/20

(52) U.S. Cl. CPC G06T 15/08; G06T 7/0002; G06T 15/20; G06T 19/20; G06T 2207/20081; G06T 2207/30168; G06T 2210/56

(57) ABSTRACT

Some embodiments of a method may include: performing a Gaussian creation process to generate a set of 3D Gaussians; passing the set of 3D Gaussians through an entropy bottleneck layer to determine a bitrate; performing a splatting process to generate a rendered image based on the set of 3D Gaussians; comparing the rendered image with a ground-truth image to generate a distortion term; determining a loss function, wherein the loss function comprises the distortion term and the bitrate of the set of 3D Gaussians; and performing a backward propagation with the loss function to update the set of 3D Gaussians.

### INCORPORATION BY REFERENCE

The present application incorporates by reference in their entirety the following applications: U.S. Non-Provisional patent application Ser. No. 18/942,127, entitled “EFFICIENT GAUSSIAN SPLATTING COMPRESSION METHOD” and filed Nov. 8, 2024 (“127 application”); and U.S. Non-Provisional patent application Ser. No. 18/923,318, entitled “DYNAMIC GAUSSIAN SPLATTING LEARNED FROM HIERARCHICAL MOTION MODEL” and filed Oct. 22, 2024 (“318 application”).

### BACKGROUND

The present application is related to Gaussian splatting.

### SUMMARY

An example method in accordance with some embodiments may include: performing a Gaussian creation process to generate a set of 3D Gaussians; passing the set of 3D Gaussians through an entropy bottleneck layer to determine a bitrate; performing a splatting process to generate a rendered image based on the set of 3D Gaussians; comparing the rendered image with a ground-truth image to generate a distortion term; determining a loss function, wherein the loss function includes the distortion term and the bitrate of the set of 3D Gaussians; and performing a backward propagation with the loss function to update the set of 3D Gaussians.

Some embodiments of the example method may further include performing an adaptive density control process, wherein the adaptive density control process adjusts quantity of 3D Gaussians in the set of 3D Gaussians.

Some embodiments of the example method may further include: passing the set of 3D Gaussians through a feature extraction process to generate a feature map; and passing the feature map though the entropy bottleneck layer to determine the bitrate.

Some embodiments of the example method may further include passing the set of 3D Gaussians through a Gaussian reconstruction process to train the feature extraction process.

For some embodiments of the example method, the Gaussian reconstruction process includes a groupwise multi-layer perceptron (MLP) process.

For some embodiments of the example method, the Gaussian reconstruction process includes a training process for the feature extraction process.

For some embodiments of the example method, the feature extraction process and the Gaussian reconstruction process form an autoencoder structure for a set of Gaussian splats generated by the splatting process.

For some embodiments of the example method, the loss function further includes a reconstructed Gaussian distortion term due to a set of reconstructed Gaussians generated by the Gaussian reconstruction process.

For some embodiments of the example method, the Gaussian reconstruction process includes generating the set of reconstructed Gaussians.

For some embodiments of the example method, determining the loss function includes: determining the reconstructed Gaussian distortion term as an amount of distortion between the set of 3D Gaussians and the set of reconstructed Gaussians; and determining the loss function based on the distortion term, the bitrate, and the reconstructed Gaussian distortion term.

For some embodiments of the example method, the bitrate includes a measurement of a feature of the feature map.

For some embodiments of the example method, passing the set of 3D Gaussians through the feature extraction process includes: passing the set of 3D Gaussians through a farthest point sampling (FPS) process; passing an output of the FPS process through a nearest neighbor (NN) grouping process; and passing an output of the NN process through a groupwise PointNet process, wherein the groupwise PointNet process outputs the feature map.

For some embodiments of the example method, determining the loss function includes determining the loss function based on the distortion term and the bitrate.

Some embodiments of the example method may further include: obtaining the ground-truth images; passing the ground-truth images through a structure from motion (SfM) process to generate a set of SfM points; and inputting the SfM points into the Gaussian creation process.

For some embodiments of the example method, inputting the SfM points into the Gaussian creation process includes initializing the Gaussian creation process.

For some embodiments of the example method, performing the splatting process includes: passing the set of 3D Gaussians through a projection process to generate a set of attributes; and passing the set of attributes through a differentiable tile rasterizer to generate the rendered image.

For some embodiments of the example method, the set of attributes includes one or more geometry attributes and one or more color attributes.

For some embodiments of the example method, wherein the differentiable tile rasterizer includes a process for determining pixel color values based on the set of attributes, and wherein the projection process includes projecting each Gaussian of the set of Gaussians onto an image plane from a perspective of a camera.

For some embodiments of the example method, passing the set of 3D Gaussians through the entropy bottleneck layer, performing the splatting process, comparing the rendered image with the ground-truth image, determining the loss function, and performing the backward propagation with the loss function are performed iteratively until a termination condition is met.

An example apparatus in accordance with some embodiments may include: a processor; and a memory storing instructions operative, when executed by the processor, to cause the apparatus to: perform a Gaussian creation process to generate a set of 3D Gaussians; pass the set of 3D Gaussians through an entropy bottleneck layer to determine a bitrate; perform a splatting process to generate a rendered image based on the set of 3D Gaussians; compare the rendered image with a ground-truth image to generate a distortion term; determine a loss function, wherein the loss function includes the distortion term and the bitrate of the set of 3D Gaussians; and perform a backward propagation with the loss function to update the set of 3D Gaussians.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example Gaussian splatting creation process according to some embodiments.

FIG. 3 is a process diagram illustrating an example Gaussian splatting optimization according to some embodiments.

FIG. 4 is a process diagram illustrating an example Gaussian splatting with an entropy bottleneck layer according to some embodiments.

FIG. 5 is a process diagram illustrating an example Gaussian splatting optimization with an entropy bottleneck layer according to some embodiments.

FIG. 6 is a process diagram illustrating an example Gaussian splatting with feature extraction and an entropy bottleneck layer according to some embodiments.

FIG. 7 is a process diagram illustrating an example Gaussian splatting optimization with feature extraction and an entropy bottleneck layer according to some embodiments.

FIG. 8 is a process diagram illustrating an example feature extraction process according to some embodiments.

FIG. 9 is a process diagram illustrating an example Gaussian reconstruction process according to some embodiments.

FIG. 10 is a flowchart illustrating an example Gaussian splatting optimization process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

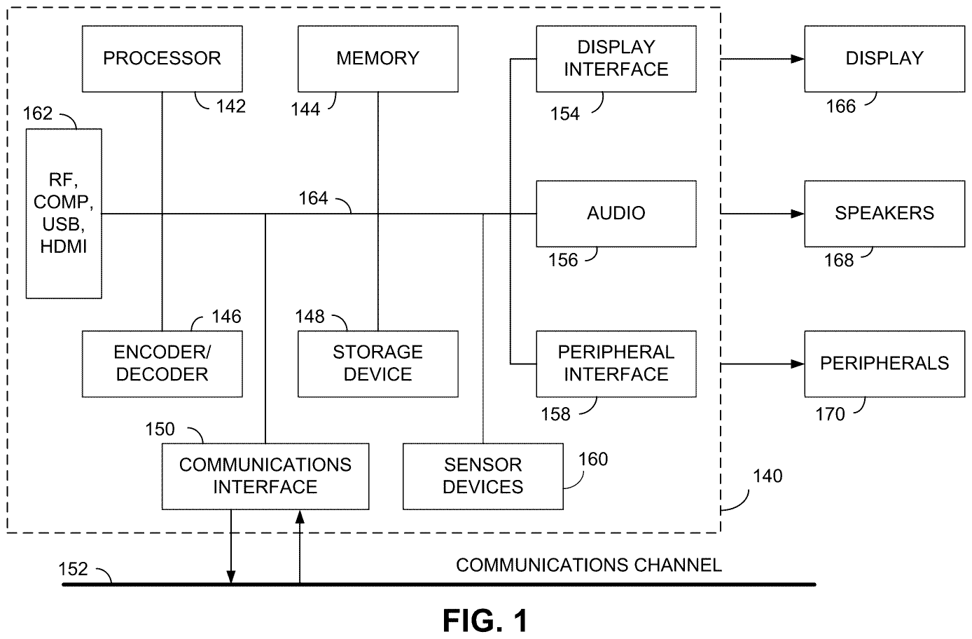

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

This application discusses the field of 3D reconstruction and rendering and targets 3D Gaussian Splatting related techniques. This field aims to develop tools for compression, analysis, interpolation, representation and understanding of 3D Gaussian Splatting.

Novel View Synthesis (NVS) is a computer graphics task aimed at generating images of scenes or objects from previously unseen viewpoints. This capability may be used with applications in virtual reality, augmented reality, 3D reconstruction, and gaming. Recently, the 3D Gaussian Splatting (3DGS) framework has emerged. By using 3D Gaussians as primitives, 3DGS effectively represents both the geometry and texture of a 3D scene, modeling the 3D scene as a collection of 3D Gaussians defined by their mean, covariance, opacity, and spherical harmonics to capture view-dependent color. With its highly parallelizable design and advancements in GPU technology, 3DGS is understood to achieve significantly faster training and rendering times than the NeRF framework.

While 3D Gaussian Splatting (3DGS) achieves fast-rendering visual output, its visual quality remains an opportunity to be further improved. The Gaussian splats optimization process gradually “overfits” a 3D scene with Gaussians. However, due to the ad-hoc and lack-of-constraint optimization of 3D Gaussians from the given multi-view images, the Gaussian splats optimization process results in redundant Gaussians with minimal impact on rendering quality. Additionally, the generated Gaussians may be irregularly scattered in space. These sub-optimally placed Gaussians have two negative impacts. First, the generated Gaussians harm the visual quality of the rendered novel scene. Secondly, the generated Gaussians also harm the performance of the downstream tasks (such as the compression of the Gaussian splats) that take the Gaussians as inputs. For some embodiments, this application aims to improve the optimization/training of the Gaussians from the given multi-view images.

### View Synthesis in an Immersive Application

For immersive applications, many view synthesis technologies display novel views. Many depth image-based rendering (DIBR) technologies use depth maps to synthesize novel views based on captured views using handcrafted algorithms. The traditional DIBR synthesis approaches often include artifacts due to occlusions between viewing positions.

With recent developments in deep learning, Neural Radiance Field (NeRF) has proven to be a remarkable method to synthesize new views of a complex scene from a limited number of captured views. During the last few years, a lot of progress has been made since the method was first presented in Mildenhall, Ben, et al., NeRF: Representing Scenes as Neural Radiance Fields for View Synthesis, 65:1 COMMS. OF THE ACM 99-106 (2021) (“Mildenhall”).

NeRF may be viewed as an implicit representation of a 3D scene. NeRF uses a neural network with filled parameters to represent a 3D scene. The neural parameters are obtained through a training procedure. In particular, the neural network is intentionally “overfitted” to a particular 3D object or scene. In this way, NeRF demonstrates much better render quality than traditional DIBR approaches. NeRF is understood to have improved rendering quality due its ability to better “predict” occluded areas than handcrafted hole filling methods with traditional DIBR. Unfortunately, computational complexity remains a hinderance since NeRF aims to evaluate the scene luminance for all the points of the 3D volume.

### 3D Gaussian Splatting

3D Gaussian Splatting is an emerging technology with a potential to overcome the computation complexity with NeRF while maintaining a high quality of view synthesis. 3D Gaussian Splatting may efficiently represent and render 3D scenes.

In the reference Kerbl, Bernhard, et al., 3D Gaussian Splatting for Real-Time Radiance Field Rendering, 42:4 ACM TRANS. GRAPH. 139-164 (2023) (“Kerbl”), 3D Gaussian Splatting was shown to have a rendering speed as fast as point-based rendering techniques, while suppressing many coinciding artifacts. 3D Gaussian Splatting utilizes 3D Gaussian as the primitive to represent the geometry and texture of a 3D scene. Specifically, 3D Gaussian Splatting models a scene as a set of 3D Gaussians, which are defined by their means, covariances, opacity, and spherical harmonics to model their view dependent colors, including RGB values.

### 3G Gaussian Splatting and Point Clouds

3D Gaussian Splatting format may be viewed as a new type of point cloud data. The means of Gaussians are point positions, and each point is associated with a new list of attributes. The covariance (as new types of point cloud attributes) together with point positions provide a complete description of surfaces. This contrasts with naïve point clouds in which the points are discrete samples on a surface, which is an incomplete representation of a surface. In addition to the three RGB values, opacity and spherical harmonics (and point cloud attributes) significantly enhance the rendering quality.

### 3D Gaussian Splatting and NeRF

While 3D Gaussian Splatting (3DGS) shares the same projection modeling motivation as neural radiance field (NeRF) rendering methods, 3DGS may avoid the need to densely sample points over the rays that project to a novel view. Instead, the 3D Gaussians are projected directly onto an image plane as 2D splats. This methodology avoids unnecessary computation in an empty space, which reduces training time and achieves real-time rendering. Moreover, by utilizing a differentiable projection and rasterization step, the Gaussian parameters may be optimized with supervision in the 2D domain than in 3D domain. For example, optimization may be done by minimizing the photometric loss between a rendered image and a ground truth view captured from the scene.

During optimization of the Gaussian parameters, Kerbl designed a highly-efficient tile-based rasterizer that allows for alpha-blending of anisotropic splats while respecting the order of the Gaussians in the 3D space. Given a set of images and camera positions, the 3D representation of a scene may be fitted in a few minutes and rendered as novel views in real time. This speed, along with the explicit nature of the Gaussian primitive that allows for easy geometry manipulation, has made 3D Gaussian Splatting one of the commonly used differential rendering techniques in a large range of applications.

However, this optimization process also generates many Gaussians due to a densification process during optimization (cloning and splitting). Furthermore, there are many attributes characterizing each Gaussian. Moreover, the generated Gaussians may be irregularly scattered in space due to a lack of constraint, which may harm the quality of the synthesized view as well as the performance of down-stream tasks.

3D Gaussian Splatting (3DGS) was proposed as a view synthesis technology suitable for rendering objects or scenes. Though 3DGS has been shown superiority in its optimization speed, the rendering quality remains to be improved. This problem arises from the creation of 3D Gaussians where there is a lack of constraint to the distribution of the generated Gaussians. To address this problem, an entropy constraint is introduced in this application to enable 3D Gaussian creation.

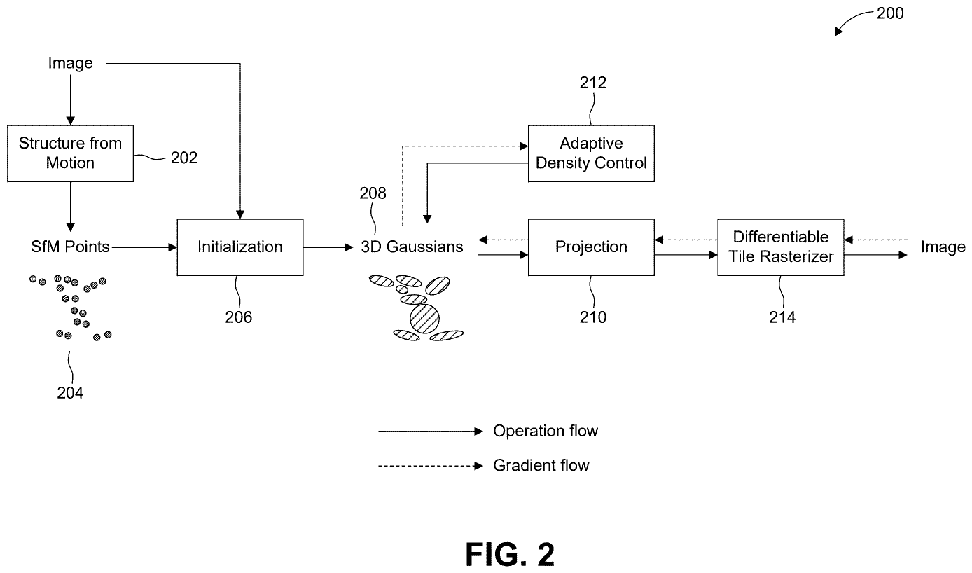

FIG. 2 is a process diagram illustrating an example Gaussian splatting creation process according to some embodiments. FIG. 2 illustrates a high-level pipeline of how 3D Gaussian Splatting work, starting with images that are captured for an object or a scene. The images may be a sequence of monocular pictures with a moving camera or a sequence of multiview pictures for some embodiments.

For an example process 200, image(s) are inputted into an SfM (Structure from Motion) block 202 to create depth information based on the input images. Using the depth information, the input images are converted to 3D points, known as SfM points. An example SfM block 202 may use a COLMAP algorithm, according to Schonberger, Johannes L. and Jan-Michael Frahm, Structure-From-Motion Revisited, IN PROC. OF THE IEEE CONF. ON COMP. VISION AND PATTERN RECOGNITION 4104-4113 (2016) (“Schonberger”).

An initialization process 206 uses the SfM points 204 to generate/initialize a set of 3D Gaussians 208. Each 3D Gaussian includes both geometry information and color information. The position and color coefficients are inherited directly from the SfM block 202, and the covariance matrix is initialized as an isotropic Gaussian with axes equal to the mean of the distance to the three closest points.

A projection block 210 projects the position of each 3D Gaussian onto an image plane from a camera's perspectives by applying an affine transformation. After the geometry relationship between 3D points and pixels is established via projection, pixel colors are computed.

A differentiable tile rasterizer 214 computes pixel color values based on the 3D Gaussian attributes. According to the geometry relationship identified in the projection step, the Gaussians are sorted according to depth with Gaussians first that are closer to the camera. For each pixel, an iterative blending process is performed over the sorted Gaussian to render the final color.

An Adaptive Density Control (ADC) block 212 aims to grow or prune Gaussian primitives. The growth of Gaussians is done via cloning or splitting of existing Gaussians based on their shape and volume. Gaussians with an opacity less than a predetermined (hard) threshold are removed or pruned.

As a complete geometry representation, 3D Gaussians are not only composed of point position (x, y, z) but also shapes (covariances of the Gaussians). The additional covariance may make a complete representation for geometry by filling up holes between sampled points. Regarding color, a 3D Gaussian is composed of opacity and spherical harmonic coefficients that have been found to be a good way to represent color from multiple viewpoints.

### Backward Propagation

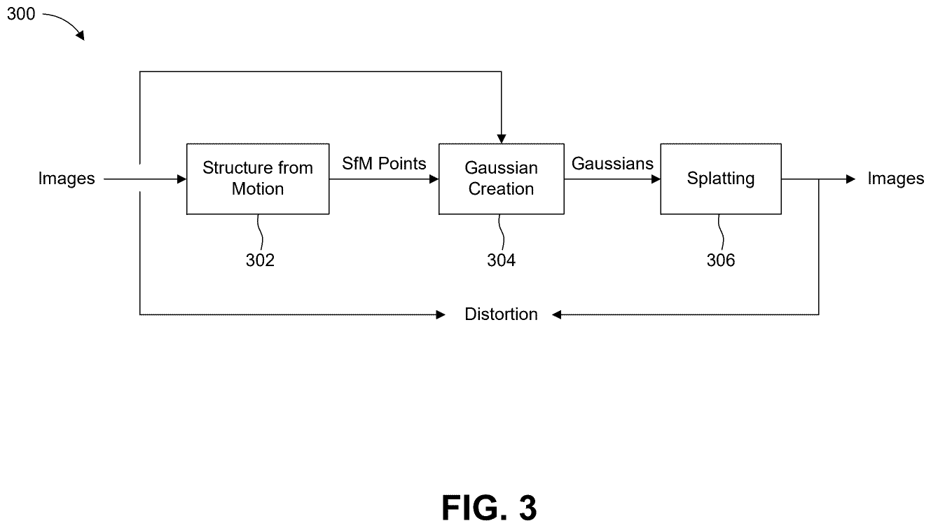

FIG. 3 is a process diagram illustrating an example Gaussian splatting optimization according to some embodiments. An example Gaussian splatting optimization process 300 may use backward propagation. For the example process 300, images are inputted into the Structure from Motion (SfM) block 302 to create depth information based on the input images. Using the depth information, the input images are converted to 3D points, known as SfM points.

Backward propagation may be used to improve the initial 3D Gaussians provided by the Gaussian creation block 304. Furthermore, the input images shown on the left side of FIG. 3 are inputted into the Gaussian creation process 304. Gaussian creation 304 is a process like any training process of a neural network model. An error is first computed by a distortion process by comparing rasterization results provided by the Splatting block 306 against ground truth image (which is the original set of input images for some embodiments). Such a comparison implies that the camera viewpoints from ground truth images are chosen to do the projection/rasterization. Based on the pixel-wise error, the associated gradients are computed. These gradients show the direction and magnitude by which the Gaussian parameters are to be updated to minimize the error. The Gaussians are updated by subtracting the gradients scaled by a learning rate. The distortion process outputs the amount of distortion that is used to update the set of Gaussians. The updated set of Gaussians are used as an input to the Splatting process 306 for a further iteration loop. For some embodiments, the Splatting process 306 and the distortion process may form an iterative loop that is repeated until a termination condition is met.

For some embodiments, the initialization process 206 of FIG. 2 is identical to the Gaussian creation process 304 of FIG. 3. For some embodiments, the projection process 210 and the differentiable tile rasterizer process 214 of FIG. 2 may be combined to form the Splatting process 306 of FIG. 3.

After presenting how 3D Gaussian Splatting works, this application discusses a brief overview on related work. The reference Fan, Zhiwen, et al., LightGaussian: Unbounded 3d Gaussian Compression with 15× Reduction and 200+ FPS, arXiv preprint arXiv:2311.17245 (2023) (“Fan”) presented LightGaussian, a method designed to transform 3D Gaussians into a more efficient and compact format. Inspired by the concept of network pruning, LightGaussian empirically identifies Gaussians that are insignificant in contributing to the scene reconstruction and adopts a pruning and recovery process. The reference Niedermayr, Simon, et al., Compressed 3D Gaussian Splatting for Accelerated Novel View Synthesis, IN PROC. OF THE IEEE/CVF CONF. ON COMP. VISION AND PATTERN RECOGNITION 10349-10358 (2024) (“Niedermayr”) proposed a compressed 3D Gaussian Splatting representation that utilizes sensitivity-aware vector clustering with quantization-aware training to compress directional colors and Gaussian parameters.

The present application introduces an entropy constraint while optimizing 3D Gaussian splatting so that the generated 3D Gaussians manifest higher regularity and uniformity in the 3D space, which not only benefits the rendered results but also eases the downstream tasks, e.g., compression, using 3D Gaussians as inputs.

### Configuration 1

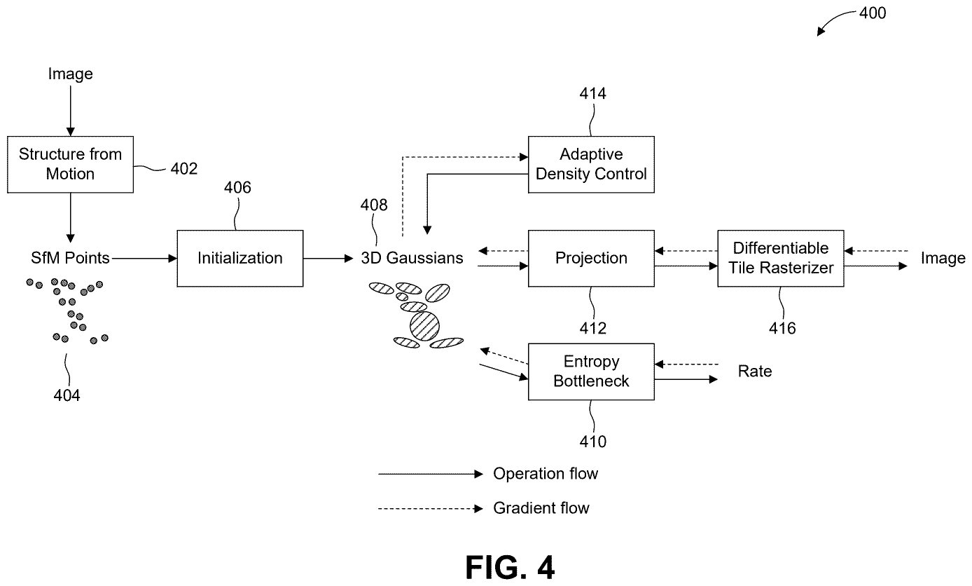

FIG. 4 is a process diagram illustrating an example Gaussian splatting with an entropy bottleneck layer according to some embodiments. FIG. 4 shows the introduction of an entropy constraint as a regularization term while optimizing the 3D Gaussians.

For an example process 400, image(s) are inputted into an SfM (Structure from Motion) block 402 to create depth information based on the input images. Using the depth information, the input images are converted to SfM points (3D points) 404. An initialization process 406 uses the SfM points 404 to generate/initialize a set of 3D Gaussians 408. An Adaptive Density Control (ADC) block 414 aims to grow or prune Gaussian primitives. A projection block 412 projects the position of each 3D Gaussian onto an image plane from a camera's perspectives. A differentiable tile rasterizer 416 computes pixel color values based on the 3D Gaussian attributes.

The difference between FIGS. 2 and 4 is the newly introduced entropy bottleneck layer 410 to directly estimate the overall bitrate of the generated Gaussians. As discussed in Balle, Johannes, et al., Variational Image Compression with a Scale Hyperprior, arXiv preprint arXiv:1802.01436 (2018) (“Balle”), the entropy bottleneck layer 410 is a differentiable neural network layer that takes as input a feature map and outputs the estimated bitrates used to encode the input feature map.

For some embodiments, each Gaussian in the 3D Gaussian Splat may be represented as a feature vector in which the i-th Gaussian may be represented as shown in Eq. 1:

$${g}_{i} = ( x , y , z , {s}_{1} , {s}_{2} , {s}_{3} , {q}_{1} , {q}_{2} , {q}_{3} , α , r , g , b , {sh}_{1} , {sh}_{2} , {sh}_{3} , … , {sh}_{45} ) \qquad ( 1 )$$

where (x, y, z) is the position of the Gaussian, (s₁, s₂, s₃, q₁, q₂, q₃) corresponds to the covariance of the Gaussian, a is the opacity, (r, g, b) gives the color of the Gaussian, and the remaining elements (sh₁, sh₂, sh₃, . . . , sh₄₅) are the spherical harmonics coefficients. By concatenating all of the feature vectors representing the Gaussians, a 2D feature map is formed, which is shown in Eq. 2:

$$G = [ \begin{matrix}{g}_{1}^{T} & {g}_{2}^{T} & {g}_{3}^{T} & … & {g}_{n}^{T}\end{matrix} ] \qquad ( 2 )$$

where n denotes the total number of Gaussians. The feature map, G, which represents the generated Gaussian Splat, is inputted to (or passed through) the entropy bottleneck layer, resulting in an estimated bitrate.

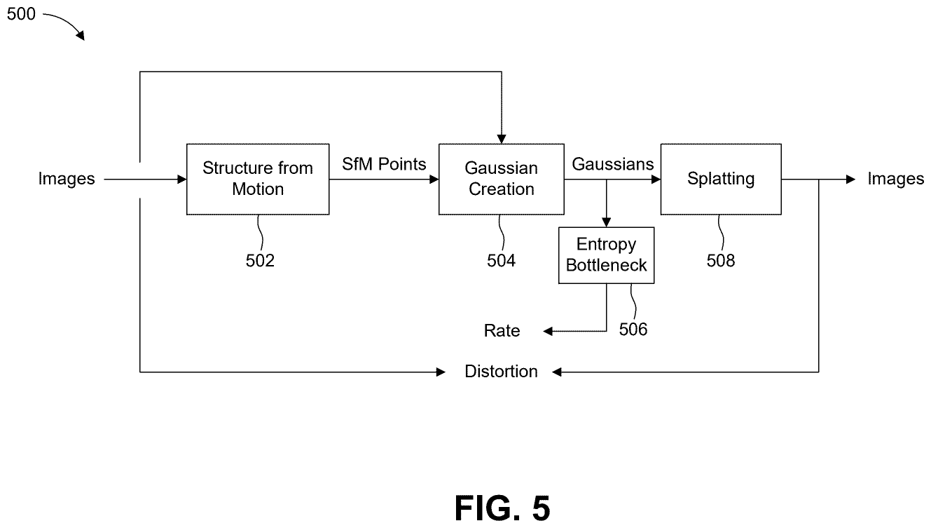

FIG. 5 is a process diagram illustrating an example Gaussian splatting optimization with an entropy bottleneck layer according to some embodiments. An example Gaussian splatting optimization process 500 may use an entropy bottleneck layer 506. For the example process 500, images are inputted into the Structure from Motion (SfM) block 502 to create depth information based on the input images. Using the depth information, the input images are converted to SfM points (3D points). Backward propagation may be used to improve the initial 3D Gaussians provided by the Gaussian creation block 504. An error is computed by comparing rasterization results provided by the Splatting block 506 against ground truth image. Based on the pixel-wise error, the associated gradients are computed. The 3D Gaussians are updated by subtracting the gradients scaled by a learning rate.

With the introduction of the entropy bottleneck layer 506, the optimization may also be updated, as shown in FIG. 5. For some embodiments, the overall loss function consists of a distortion term and a rate term. Suppose the distortion which is determined by comparing the original image and the rendered image may be notated as D. The estimated rate output by the entropy bottleneck layer may notated as R. The loss function, for some embodiments, may be given by Eq. 3:

$$L = D + λ R \qquad ( 3 )$$

where λ is a tradeoff parameter between rate and distortion. By optimizing a Gaussian Splat using the loss function (L), a Gaussian Splat may be refined iteratively by considering the entropy. Entropy is a concept reflecting the amount of information represented by a signal. Rate refers to the bitrate used to encode an input signal. Rate may be viewed as a measure of entropy, typically an approximation of entropy.

### Configuration 2

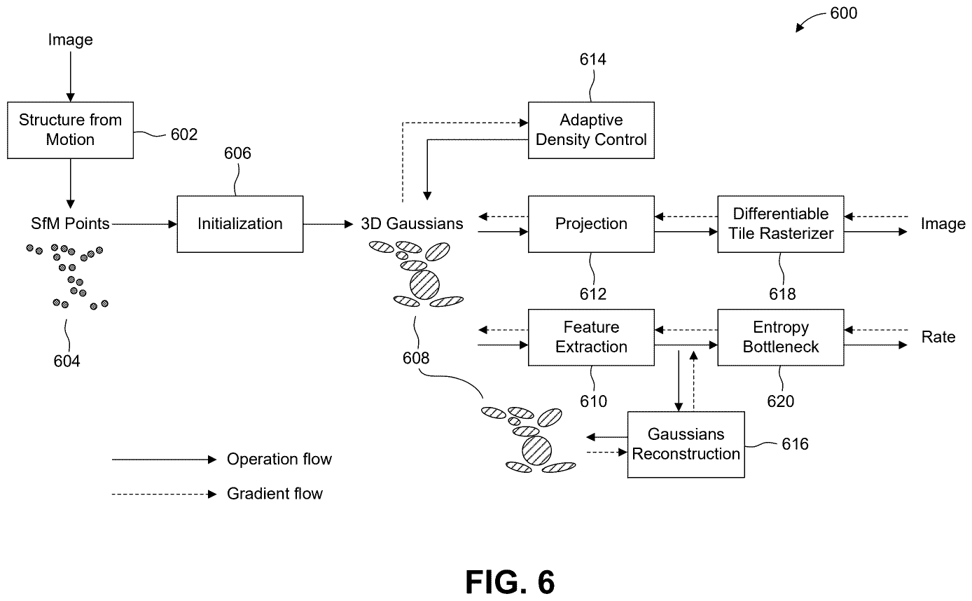

FIG. 6 is a process diagram illustrating an example Gaussian splatting with feature extraction and an entropy bottleneck layer according to some embodiments. For an example process 600, image(s) are inputted into an SfM (Structure from Motion) block 602 to create depth information based on the input images. Using the depth information, the input images are converted to SfM points (3D points) 604. An initialization process 606 uses the SfM points 604 to generate/initialize a set of 3D Gaussians 608. An Adaptive Density Control (ADC) block 614 aims to grow or prune Gaussian primitives. A projection block 612 projects the position of each 3D Gaussian onto an image plane from a camera's perspectives. A differentiable tile rasterizer 618 computes pixel color values based on the 3D Gaussian attributes.

In Configuration 1, the entropy bottleneck layer takes each individual Gaussian as input and does not consider the interaction of neighboring Gaussians. Additionally, the parameters of each Gaussian are directly regularized by the entropy bottleneck, which also ignores the interactions between different Gaussian parameters. Configuration 2 considers these interactions.

In Configuration 2, a feature extraction block 610 is inserted to process the Gaussian Splat. Particularly, the feature extraction block 610 takes as input the Gaussian Splat and outputs a feature map representing/summarizing the Gaussian Splat in the latent space. The feature map is fed into the entropy bottleneck layer 620 for bitrate estimation and regularization. Configuration 2 is shown in FIG. 6.

A Gaussian reconstruction block 616 is also appended after the feature extraction 610. The Gaussian reconstruction block 616 endeavors to reconstruct the Gaussians inputted to the feature extraction 610. The purpose of the Gaussian reconstruction block 616 is to train the feature extraction 610, enabling the feature extraction 610 to extract meaningful features rather than outputting trivial results (e.g., a feature map with all zeros). The feature extraction 610 and the Gaussian reconstruction 616 form an autoencoder structure for Gaussian Splats. Additionally, in Configuration 2, the entropy bottleneck layer 620 measures the bitrate of the extracted feature, rather than directly measuring the bitrate of the Gaussian Splat.

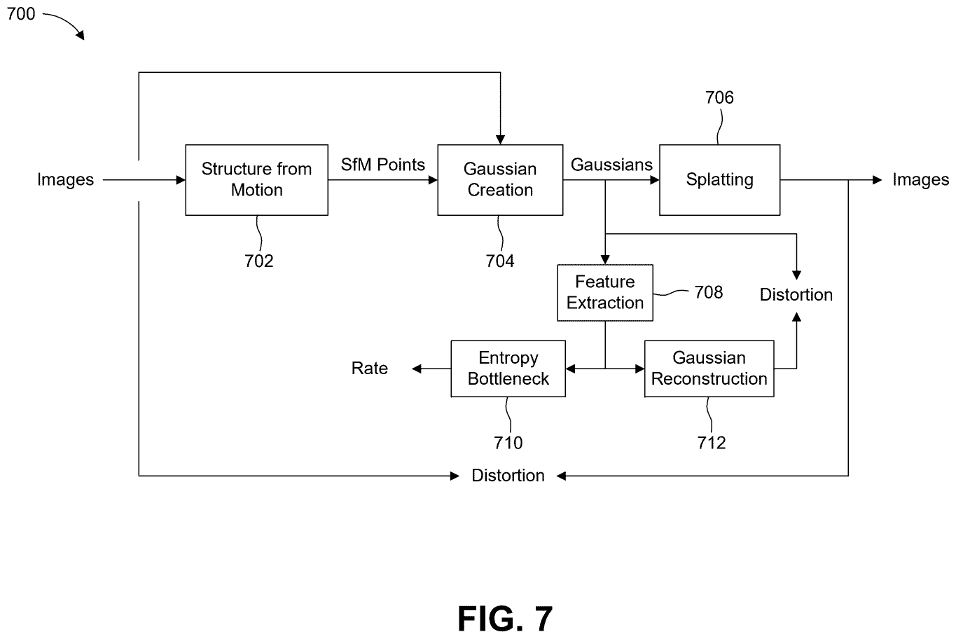

FIG. 7 is a process diagram illustrating an example Gaussian splatting optimization with feature extraction and an entropy bottleneck layer according to some embodiments. An example Gaussian splatting optimization process 700 may use feature extraction 708, Gaussian reconstruction 712, and an entropy bottleneck layer 710. For the example process 700, images are inputted into the Structure from Motion (SfM) block 702 to create depth information based on the input images. Using the depth information, the input images are converted to SfM points (3D points). Backward propagation may be used to improve the initial 3D Gaussians provided by the Gaussian creation block 704. An error is computed by comparing rasterization results provided by the Splatting block 706 against ground truth image. Based on the pixel-wise error, the associated gradients are computed. The 3D Gaussians are updated by subtracting the gradients scaled by a learning rate. A feature extraction block 708 processes the Gaussian Splat and outputs a feature map representing the Gaussian Splat in the latent space. The feature map is fed into the entropy bottleneck layer 710 for bitrate estimation and regularization. The Gaussian reconstruction block 712 trains the feature extraction 708.

The optimization of Configuration 2 is shown in FIG. 7, in addition to the image distortion term D and the rate term R presented in Configuration 1. For Configuration 2, an additional term measuring the distortion between the input Gaussians and the reconstructed Gaussians are computed, which is denoted as D_{G}. As a result, the overall loss function is given by Eq. 4:

$${L}_{2} = D + λ R + μ {D}_{G} \qquad ( 4 )$$

where μ is the tradeoff parameter for the Gaussian distortion term. By optimizing with the loss function L₂, a Gaussian Splat considering the entropy would be gradually generated.

### Feature Extraction Example Design

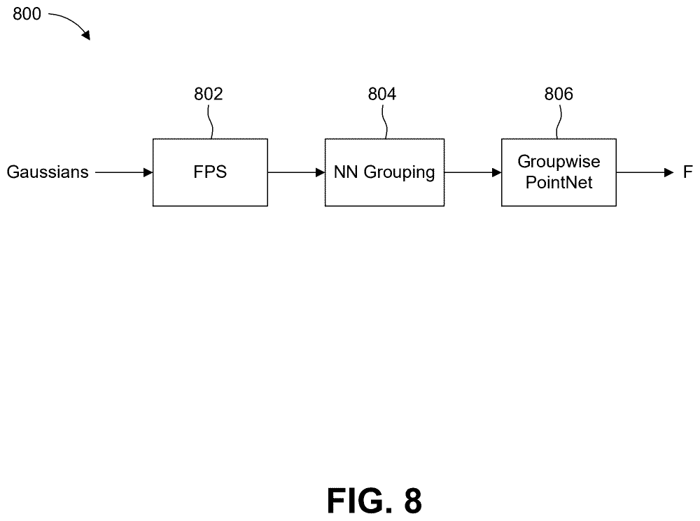

FIG. 8 is a process diagram illustrating an example feature extraction process according to some embodiments. For some embodiments, the feature extraction block takes the network design of PointNet++, which is discussed in Qi, Charles R., et al., Pointnet++: Deep Hierarchical Feature Learning on Point Sets in a Metric Space, ADVANCES IN NEURAL INFO. PROCESSING SYSTEMS 30 (2017) (“Qi 1”) and shown in FIG. 8. Using the PointNet++ architecture lets the feature extraction process to also consider nearby Gaussians during the extraction process.

Firstly, an example feature extraction process 800 inputs Gaussians into a Farthest Point Sampling (FPS) block 802. The FPS block 802, which is discussed in Qi 1, is applied to identify a few center points of the Gaussians. Suppose m center points are identified. Next, a nearest neighbor (NN) grouping block 804 is applied to form m groups of Gaussians by searching for the nearest neighbors of each center. The m groups of Gaussians are then fed to the Groupwise PointNet block 806. The Groupwise PointNet block 806 is discussed in Qi, Charles R., et al., Pointnet: Deep Learning on Point Sets for 3D Classification and Segmentation, PROC. OF THE IEEE CONF. ON COMP. VISION AND PATTERN RECOGNITION (2017) (“Qi 2”), where, from each group, a feature vector is extracted. These m feature vectors together constitute a feature map F, which represents the input Gaussians. For the Groupwise PointNet block 806, instead of extracting features from only the (x, y, z) positions, the entire vector gᵢ representing the complete information of the Gaussian may be used as the input.

### Gaussian Reconstruction Example Design

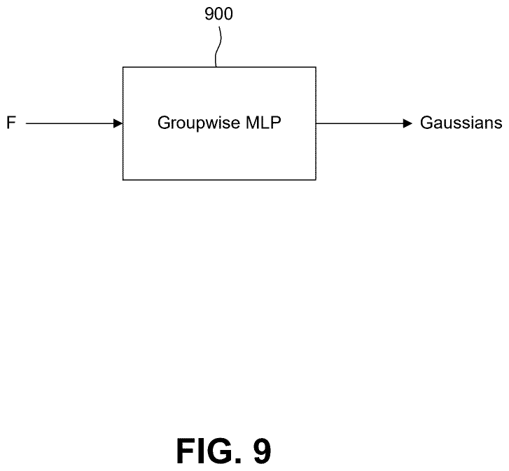

FIG. 9 is a process diagram illustrating an example Gaussian reconstruction process according to some embodiments. The Gaussian reconstruction block 900 may be a few multi-layer perceptron (MLP) layers, as shown in FIG. 9. Each feature vector f in F may be processed with the MLP layers, which directly reconstruct the parameters of the associated Gaussians. These reconstructed Gaussians may be used for the computation of the distortion D_{G}.

3D Gaussian Splatting is an emerging technology for novel view synthesis with low computational cost. However, further improvements in rendering quality are highly desired. This application introduces the entropy bottleneck layer to regularize the optimization process of 3D Gaussian Splatting. The entropy bottleneck layer may be used for improving the rendering quality and for letting the generated Gaussians to be more regularly distributed. Such a distribution may benefit downstream tasks, such as compression.

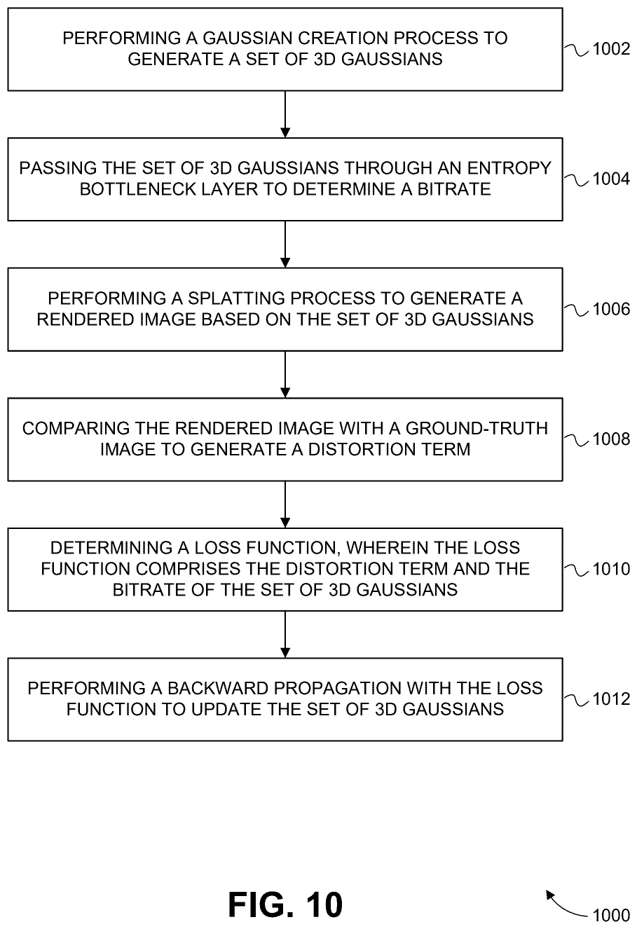

FIG. 10 is a flowchart illustrating an example Gaussian splatting optimization process according to some embodiments. For some embodiments, an example process 1000 may include performing 1002 a Gaussian creation process to generate a set of 3D Gaussians. For some embodiments, the example process 1000 may further include passing 1004 the set of 3D Gaussians through an entropy bottleneck layer to determine a bitrate. For some embodiments, the example process 1000 may further include performing 1006 a splatting process to generate a rendered image based on the set of 3D Gaussians. For some embodiments, the example process 1000 may further include comparing 1008 the rendered image with a ground-truth image to generate a distortion term. For some embodiments, the example process 1000 may further include determining 1010 a loss function, wherein the loss function comprises the distortion term and the bitrate of the set of 3D Gaussians. For some embodiments, the example process 1000 may further include performing 1012 a backward propagation with the loss function to update the set of 3D Gaussians.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example method in accordance with some embodiments may include: performing a Gaussian creation process to generate a set of 3D Gaussians; passing the set of 3D Gaussians through an entropy bottleneck layer to determine a bitrate; performing a splatting process to generate a rendered image based on the set of 3D Gaussians; comparing the rendered image with a ground-truth image to generate a distortion term; determining a loss function, wherein the loss function includes the distortion term and the bitrate of the set of 3D Gaussians; and performing a backward propagation with the loss function to update the set of 3D Gaussians.

Some embodiments of the example method may further include performing an adaptive density control process, wherein the adaptive density control process adjusts quantity of 3D Gaussians in the set of 3D Gaussians.

Some embodiments of the example method may further include: passing the set of 3D Gaussians through a feature extraction process to generate a feature map; and passing the feature map though the entropy bottleneck layer to determine the bitrate.

Some embodiments of the example method may further include passing the set of 3D Gaussians through a Gaussian reconstruction process to train the feature extraction process.

For some embodiments of the example method, the Gaussian reconstruction process includes a groupwise multi-layer perceptron (MLP) process.

For some embodiments of the example method, the Gaussian reconstruction process includes a training process for the feature extraction process.

For some embodiments of the example method, the feature extraction process and the Gaussian reconstruction process form an autoencoder structure for a set of Gaussian splats generated by the splatting process.

For some embodiments of the example method, the loss function further includes a reconstructed Gaussian distortion term due to a set of reconstructed Gaussians generated by the Gaussian reconstruction process.

For some embodiments of the example method, the Gaussian reconstruction process includes generating the set of reconstructed Gaussians.

For some embodiments of the example method, determining the loss function includes: determining the reconstructed Gaussian distortion term as an amount of distortion between the set of 3D Gaussians and the set of reconstructed Gaussians; and determining the loss function based on the distortion term, the bitrate, and the reconstructed Gaussian distortion term.

For some embodiments of the example method, the bitrate includes a measurement of a feature of the feature map.

For some embodiments of the example method, passing the set of 3D Gaussians through the feature extraction process includes: passing the set of 3D Gaussians through a farthest point sampling (FPS) process; passing an output of the FPS process through a nearest neighbor (NN) grouping process; and passing an output of the NN process through a groupwise PointNet process, wherein the groupwise PointNet process outputs the feature map.

For some embodiments of the example method, determining the loss function includes determining the loss function based on the distortion term and the bitrate.

Some embodiments of the example method may further include: obtaining the ground-truth images; passing the ground-truth images through a structure from motion (SfM) process to generate a set of SfM points; and inputting the SfM points into the Gaussian creation process.

For some embodiments of the example method, inputting the SfM points into the Gaussian creation process includes initializing the Gaussian creation process.

For some embodiments of the example method, performing the splatting process includes: passing the set of 3D Gaussians through a projection process to generate a set of attributes; and passing the set of attributes through a differentiable tile rasterizer to generate the rendered image.

For some embodiments of the example method, the set of attributes includes one or more geometry attributes and one or more color attributes.

For some embodiments of the example method, wherein the differentiable tile rasterizer includes a process for determining pixel color values based on the set of attributes, and wherein the projection process includes projecting each Gaussian of the set of Gaussians onto an image plane from a perspective of a camera.

For some embodiments of the example method, passing the set of 3D Gaussians through the entropy bottleneck layer, performing the splatting process, comparing the rendered image with the ground-truth image, determining the loss function, and performing the backward propagation with the loss function are performed iteratively until a termination condition is met.

An example apparatus in accordance with some embodiments may include: a processor; and a memory storing instructions operative, when executed by the processor, to cause the apparatus to: perform a Gaussian creation process to generate a set of 3D Gaussians; pass the set of 3D Gaussians through an entropy bottleneck layer to determine a bitrate; perform a splatting process to generate a rendered image based on the set of 3D Gaussians; compare the rendered image with a ground-truth image to generate a distortion term; determine a loss function, wherein the loss function includes the distortion term and the bitrate of the set of 3D Gaussians; and perform a backward propagation with the loss function to update the set of 3D Gaussians.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
performing a Gaussian creation process to generate a set of 3D Gaussians;
passing the set of 3D Gaussians through an entropy bottleneck layer to determine a bitrate;
performing a splatting process to generate a rendered image based on the set of 3D Gaussians;
comparing the rendered image with a ground-truth image to generate a distortion term;
determining a loss function,
wherein the loss function comprises the distortion term and the bitrate of the set of 3D Gaussians; and
performing a backward propagation with the loss function to update the set of 3D Gaussians.

2. The method of claim 1, further comprising:
performing an adaptive density control process,
wherein the adaptive density control process adjusts quantity of 3D Gaussians in the set of 3D Gaussians.

3. The method of claim 1, further comprising:
passing the set of 3D Gaussians through a feature extraction process to generate a feature map; and
passing the feature map though the entropy bottleneck layer to determine the bitrate.

4. The method of claim 3, further comprising passing the set of 3D Gaussians through a Gaussian reconstruction process to train the feature extraction process.

5. The method of claim 4, wherein the Gaussian reconstruction process comprises a groupwise multi-layer perceptron (MLP) process.

6. The method of claim 4, wherein the Gaussian reconstruction process comprises a training process for the feature extraction process.

7. The method of claim 4, wherein the feature extraction process and the Gaussian reconstruction process form an autoencoder structure for a set of Gaussian splats generated by the splatting process.

8. The method of claim 4, wherein the loss function further comprises a reconstructed Gaussian distortion term due to a set of reconstructed Gaussians generated by the Gaussian reconstruction process.

9. The method of claim 8, wherein the Gaussian reconstruction process comprises generating the set of reconstructed Gaussians.

10. The method of claim 9, wherein determining the loss function comprises:
determining the reconstructed Gaussian distortion term as an amount of distortion between the set of 3D Gaussians and the set of reconstructed Gaussians; and
determining the loss function based on the distortion term, the bitrate, and the reconstructed Gaussian distortion term.

11. The method of claim 3, wherein the bitrate comprises a measurement of a feature of the feature map.

12. The method of claim 3, wherein passing the set of 3D Gaussians through the feature extraction process comprises:
passing the set of 3D Gaussians through a farthest point sampling (FPS) process;
passing an output of the FPS process through a nearest neighbor (NN) grouping process; and
passing an output of the NN process through a groupwise PointNet process,
wherein the groupwise PointNet process outputs the feature map.

13. The method of claim 1, wherein determining the loss function comprises determining the loss function based on the distortion term and the bitrate.

14. The method of claim 1, further comprising:
obtaining the ground-truth images;
passing the ground-truth images through a structure from motion (SfM) process to generate a set of SfM points; and
inputting the SfM points into the Gaussian creation process.

15. The method of claim 14, wherein inputting the SfM points into the Gaussian creation process comprises initializing the Gaussian creation process.

16. The method of claim 1, wherein performing the splatting process comprises:
passing the set of 3D Gaussians through a projection process to generate a set of attributes; and
passing the set of attributes through a differentiable tile rasterizer to generate the rendered image.

17. The method of claim 16, wherein the set of attributes comprises one or more geometry attributes and one or more color attributes.

18. The method of claim 17,
wherein the differentiable tile rasterizer comprises a process for determining pixel color values based on the set of attributes, and
wherein the projection process comprises projecting each Gaussian of the set of Gaussians onto an image plane from a perspective of a camera.

19. The method of claim 1, wherein passing the set of 3D Gaussians through the entropy bottleneck layer, performing the splatting process, comparing the rendered image with the ground-truth image, determining the loss function, and performing the backward propagation with the loss function are performed iteratively until a termination condition is met.

20. An apparatus comprising:
a processor; and
a memory storing instructions operative, when executed by the processor, to cause the apparatus to:
perform a Gaussian creation process to generate a set of 3D Gaussians;
pass the set of 3D Gaussians through an entropy bottleneck layer to determine a bitrate;
perform a splatting process to generate a rendered image based on the set of 3D Gaussians;
compare the rendered image with a ground-truth image to generate a distortion term;
determine a loss function,
wherein the loss function comprises the distortion term and the bitrate of the set of 3D Gaussians; and
perform a backward propagation with the loss function to update the set of 3D Gaussians.
